(19) United States
(12) Patent Application Publication
(10) Pub. No.: US 2019/0008093 A1
(43) Pub. Date: Jan. 10, 2019

(54) SYSTEM FOR DRIVING MATERIAL CUT AND APPLIED ON A CUTTING PLATFORM FOR A GRAIN HARVESTER

(71) Applicant: Vanderlei KAMPHORST, Rio Grande do Sul (BR)

(72) Inventor: Vanderlei KAMPHORST, Rio Grande do Sul (BR)

(21) Appl. No.: 15/642,785

(22) Filed: Jul. 6, 2017

(51) Int. Cl. A01D 61/00; A01D 61/04; A01D 57/12

(52) U.S. Cl. CPC A01D 61/002; A01D 57/12; A01D 61/04

(57) ABSTRACT

The present invention relates to two systems for driving cut material: a trailing system (B1) and a self-cleaning and suspended conveyor system (B2) applied on a cutting platform for grain harvesters, where the material cut by the cutting system is driven from the sides to the center of the platform (14) by element of two chain systems, wherein in the drag system (B1) multiple toes are mounted on a horizontal chain and in the self-cleaning and suspended conveyor system (B2) and multiple cast (perforated) cradles are mounted on the horizontal chain. In this way, both systems, drag and/or drop conveyors, shall be driven by hydraulic or electric motors or a mechanical system and a cutting platform can use one or the other conveyor systems, that is, the drag or suspended systems shall be used.

### TECHNICAL FIELD

The following descriptive report for the invention refers to the development of a system for driving material cut by the cutting system of a grain harvesting platform where the reel drives the material cut to the platform table and this material is driven from the sides to the center through two driving arrangements that use as a base a system of chains mounted in the horizontal direction.

### STATE OF THE ART

According to Manteufel (2012), modern agriculture demands quality and productivity in operations comprising it, in which competitiveness has been leading companies to reduce costs and put high quality products in the consumer market. This reality poses challenges since, in addition to being a complex activity, agriculture often depends on climatic aspects that can contribute to productivity increase as well as adversely affecting it. To minimize grain losses risks during harvesting, growers have been looking for more productive grain harvesters with some lower loss rate.

Bronson and McDowell (2010) show that agricultural machinery manufacturers from around the world have identified the need to increase productivity of their grain harvesters and have identified that, in addition to making improvements to harvesters performance, they should make improvements to the cutting platform. From this emerged the concept of a cutting platform which can employ a helicoidal conveyor to take the material cut to the center of the platform or employ rubber conveyors to transport the material harvested to the center of the platform, thereby improving the flow of the material harvested between the cutting platform and the grain harvester.

The helicoidal conveyor consists of a cylinder extending across the width of the cutting bar, divided into three sections, being two side sections arranged with helicoidal flanges, leading the material to the center of the helicoidal conveyor and the central section having adjustable retractable toes to control the amount of material to be fed (Balastreire, 1987). This can be seen in documents U.S. Pat. No. 2,832,187 and U.S. Pat. No. 3,683,601.

The cutting platform with conveyor belts uses flat and wide belts to drive the material harvested to the center of the platform. The arrangement and quantity of belts may vary by platform size. One type of conveyor belt platform has two side belts on each side of the platform that drive the material harvested longitudinally to the center of the platform, where a central conveyor belt moves the material harvested laterally into the cylinder feeder. Each belt is wound on a pair of rollers, one of them being the driving roller and the other driven, which has the function of transmitting movement to the conveyor belts (Bronson and McDowell, 2010). Such a platform can be seen in U.S. Pat. No. 7,640,720 and U.S. Pat. No. 8,272,198.

According to Bronson and McDowell (2010), one of the advantages of a cutting platform with the concept of conveyor belts is that large quantities of material can be transported unobstructed. With a cutting platform equipped with a helicoidal conveyor, the material harvested can be caught between the helicoidal conveyor and the back plate of the platform chassis, causing the harvester to stop. With a platform equipped with conveyor belts, the harvested material is transported at the top of the belt, reducing the possibility that the material is caught in some other component of the cutting platform.

A cutting platform is described in document BR 20 2015 011761-8, where the alternative cutting system cuts the product, a rotational reel that pulls the product towards a chain system in the lower base of the platform, arranged on both the right and left sides and an upper chain or auger on the right and on the left sides, which shall drag the product from the sides to the center of the platform.

### DISCUSSION

The platform using the helicoidal conveyor is prone to bushing since the material cut may be pressed between the scrolls of the helicoidal one and the metal walls. In the platform that uses conveyors this type of problem is minimized because with the use of the “draper” system the material is driven to the center by means of conveyors but the “draper” system presents a low rate of durability due to the work load where it is applied, causing high maintenance costs.

### SUMMARY

Thus, due to considerations related to the state of the art discussed above, it is one of the objectives of the present invention the development of a system for driving cut material applied in cutting platforms for grain harvesters, where some means of transporting the cut material was used from the sides to the center through a system of chains mounted in the horizontal direction and these chains have two concepts to effect the conveyor. And with such new concepts we aim to have homogeneous feeding for the harvester, offering high performance for the whole (platform and harvester), with low maintenance costs when considering with the draper system.

In such chains two arrangements can be used to drive the material harvested, where one has:
First arrangement: The first arrangement relates to the drag conveyor system consisting of a plurality of chain-mounted toes that move the cut material to the center of the platform. This material cut, upon reaching the center of the platform, is driven into the harvester by means of a conveyor belt.

The second suspended and self-cleaning conveyor arrangement consists of a plurality of cast (perforated) cradles which shall lead the cut material in a suspended (raised) manner to the center of the platform with a self-cleaning system by drilling the cradles. This material cut, upon reaching the center of the platform, is driven into the harvester by means of a conveyor belt.

### DESCRIPTION

The characterization of the present document for the invention is made by means of drawings representative of the system for driving the material cut by the cutting system of a grain harvester platform, so that the equipment can be fully reproduced by some suitable technique, allowing full characterization of the functionality of the object requested.

Based on the Figures developed that express the best form or preferential form of bringing about the product now idealized, the descriptive part of the report is established through some detailed and consecutive numbering, where it clarifies aspects that may be implied by the representation adopted, in order to clearly determine the protection now intended.

Such figures are for illustration purposes only and may present variations, as long as they do not veer from what was initially proposed.

In this case one has:

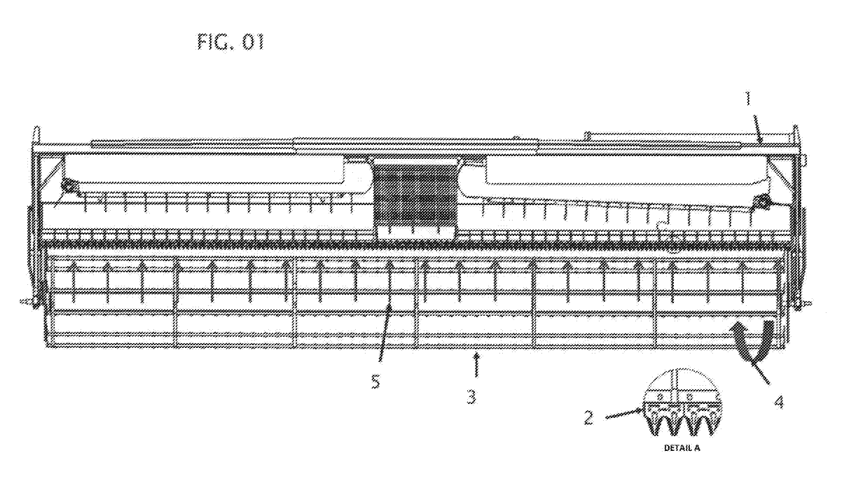

FIG. 1 shows the system top view proposed with all elements and [0018]

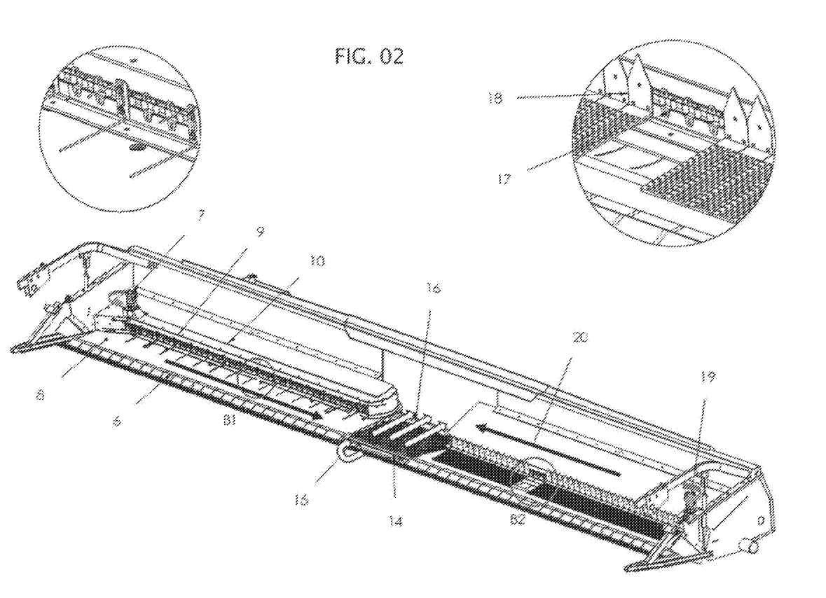

FIG. 2 shows two new concepts (arrangements) for transporting harvested material mounted on a chain in the horizontal direction, where the first arrangement (B1) refers to the multi-toed drag conveyor system mounted on a horizontal direction chain and base plates and fixed and movable protection. The second arrangement (B2) refers to the suspended and self-cleaning conveyor system with multiple cast (perforated) cradles and mounted on a chain in the horizontal direction of the harvested product.

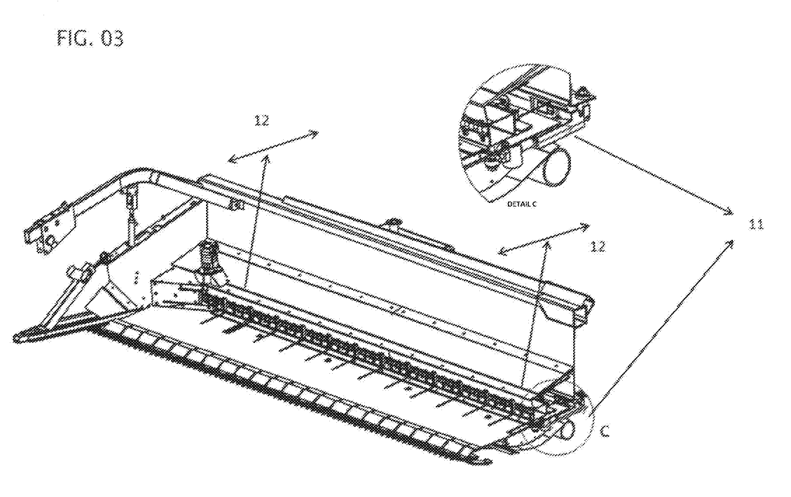

FIG. 3 shows how the displacement is enabled (back-and-forth) of the drag conveyor system with back-and-forth chains and plates (PE-UHMW).

Some preferred form of construction of the proposed conveyor systems employs a cutting platform consisting of some main chassis (1) in which all the elements are connected, wherein said platform discloses the reciprocating cut-off system (2) which cuts the material to be harvested. With the aid of the reel (3) the material is driven through a rotational movement (4) in the direction indicated by the arrows (5).

In the first arrangement, which features a drag conveyor system, the flow (6) occurs from the side to the center through toe dragging (B1). This chain system can be driven by a hydraulic motor or an electric or mechanical system (7). The displacement velocity of the driven chain shall be variable due to the volume density of the product harvested, speed of the machine displacement and other factors such as straw moisture and crop variety. The entire toe system mentioned above and protected by polymeric material plates (PE-UHMW), which has some low coefficient of friction, allowing the sliding of the harvested material, facilitates the drag work done by the chain and toe system.

For better understanding, the description of the assembly of the PE-UHMW plates set and of the set of tensile chains shall be provided.

The plate system consists of three plates, each with their respective functions.

The base plate (8) forms the base on which the chain system (B1) is mounted and connects the cutting system and the chain system, allowing flexibility between the two.

The movable protection plate (9) is mounted on the chain system (B1) and has the function of isolating the harvested material so that its drag by the chain system toes is only in the direction of the end towards the center of the platform, avoiding the accumulation of material and maintaining a continuous flow of material to the central part of the platform.

The fixed protective plate (10) is mounted on the movable plate (9) and set on the platform chassis (1) and is intended to prevent the accumulation of material between the platform chassis (1) and the chain system (B1). It also allows the displacement of the chain system (B1) and the movable plate (9) back-and-forth through the linear actuators (11), producing the back-and-forth movement (12).

All material moving from the ends to the center through the chain and plate systems upon reaching the center of the platform is driven into the harvester through a conveyor (14) which is driven by a hydraulic motor, an electric or mechanical system with variable speed according to the volumetric density of the material to be harvested, speed of machine displacement and other factors such as straw moisture and crop variety. The belt (14) moves in the direction indicated (16) and the harvested material is moved (15) into the harvester.

The back-and-forth movement (12) of the movable plates and chain system is made by means of two linear actuators, one at each end (DETAIL C), wherein the linear actuator (11) moves by independently acting and withdrawing, producing the forward or backward (back-and-forth) displacement of the system, according to items 12 and 13. Such displacement shall depend on the volumetric density of the material to be harvested, the speed of the machine displacement and other factors such as straw moisture and crop variety.

The second arrangement describes a self-cleaning suspended conveyor system consisting of a chain in the horizontal direction and multiple elements folded with suitable degrees (B2), in which are assembled (18) and in which the harvested products shall be transported in a suspended manner, which shall contribute to maintaining the grain quality as there shall be no impact on it. These multiple elements shall be cast (perforated) to allow the soil collected along with the product harvested in the cutting process to be released to the soil before entering the harvester.

The product cut by the cutting system is driven with the help of the reel (3) to the cradle of the suspended conveyor system (B2). The system is driven with hydraulic, electric or mechanical motors according to (19), which shall move the chain of the suspended conveyor in the direction indicated (20), causing the displacement of the product harvested from the side to the center of the platform. Such displacement shall be variable. All products, when arriving in the center of the platform, shall be taken to the interior of the harvester with the aid of a conveyor belt. The belt displacement (14) follows the direction of the arrows (15) and the product enters the harvester according to the arrows (16).

1. SYSTEMS FOR DRIVING CUT MATERIAL APPLIED IN CUTTING PLATFORMS FOR GRAIN HARVESTERS, wherein said cutting platform consists of a main chassis (1), in which all the elements are connected, wherein said platform presents the alternative movement cutting system (2) that effects the cutting of the material to be harvested and the reel (3) is responsible for driving the material by a rotating movement (4) to the platform table, characterized by the material cut by the cutting system being led from the sides to the center of the platform (14) by means of two conveyor systems mounted horizontally on the chain, called: drag conveyor system and self-cleaning suspended conveyor system.

2. SYSTEM, according to claim 1 and characterized by the drag conveyor system consisting of multiple toes mounted on a horizontal chain (B1) and said chain system is driven by a motor (7) which may be either hydraulic, electric or mechanical. It also has a base plates system for fixed and mobile protection as well as a back-and-forth driving system that shall advance or retreat the drag system.

3. SYSTEM, according to claim 1 and characterized in that the self-cleaning and suspended conveyor system consists of multiple cast (perforated) cradles mounted on a horizontal chain (B2), said motor driven system (19) being either hydraulic, electric or mechanical, presenting its cast (perforated) cradles where there shall be self-cleaning of the product harvested.

4. SYSTEM, according to claim 2 is characterized by having a three-plate system (8, 9 and 10) where:
The base plate (8) forms the base on which the chain system (B1) is mounted and connects the cutting system (2) to the chain system (B1);
The movable protection plate (9) is mounted on the chain system (B1) and isolates the harvested material so that the drag is only in the direction of the end towards the center of the platform (14).
The fixed protection plate 10 is mounted on the movable plate (9) and is set on the platform chassis, preventing the accumulation of material between the chassis (1) of the platform and the chain system (B1).

5. SYSTEM, according to claim 2 and characterized in that the fixed protection plate (10) enables the chain system (B1) and the movable plate (9) to be moved back-and-forth through the linear actuators (11), producing the back-and-forth movement as shown in item 12 and said system is actuated by linear actuators (11).

6. SYSTEM, according to claim 2 and characterized by the multi-toed chain system (B1) which shall lead the material to the continuously moving central conveyor (14) (15) and the harvested material is moved (16) to the interior of the harvester.

7. SYSTEM, according to claim 3 and characterized by the chain system (B2), consisting of a plurality of cast (perforated) cradles, mounted on the chain which shall lead the material to the continuously moving central conveyor (14) and the material harvested (16) into the harvester.

8. SYSTEM, still according to claim 3 and characterized by the multiple cast (perforated) cradles (18), shall, in addition to transporting the harvested product, clean dirt and dust through the multiple holes that make up the cast (perforated) cradle.
